(19) United States
(12) Patent Application Publication
(10) Pub. No.: US 2025/0015330 A1
(43) Pub. Date: Jan. 9, 2025

(54) MEMBRANE ELECTRODE ASSEMBLY

(71) Applicant: TOYOTA JIDOSHA KABUSHIKI KAISHA, Toyota-shi (JP)

(72) Inventors: Shunsuke TAKAHASHI, Toyota-shi (JP); Masayuki KIMURA, Toyota-shi (JP)

(73) Assignee: TOYOTA JIDOSHA KABUSHIKI KAISHA, Toyota-shi (JP)

(21) Appl. No.: 18/751,605

(22) Filed: Jun. 24, 2024

(30) Foreign Application Priority Data
Jul. 4, 2023 (JP) 2023-109733

(51) Int. Cl. H01M 8/1048; H01M 4/88; H01M 8/10; H01M 8/1004; H01M 8/1027; H01M 8/103

(52) U.S. Cl. CPC H01M 8/1048; H01M 4/881; H01M 8/1004; H01M 8/1027; H01M 8/103; H01M 2008/1095; H01M 2300/0082; H01M 2300/0091

(57) ABSTRACT

Provided is a membrane electrode assembly having excellent durability. A membrane electrode assembly includes: a solid polymer electrolyte membrane; an anode catalyst layer disposed on one surface of the solid polymer electrolyte membrane; and a cathode catalyst layer disposed on the other surface of the solid polymer electrolyte membrane. The membrane electrode assembly includes metal ions selected from cerium ions and manganese ions and a host compound capable of forming an inclusion compound with the metal ions. The host compound is a crown ether compound comprising an amino group or a salt thereof.

### CROSS REFERENCE TO RELATED APPLICATIONS

The present application claims priority from Japanese patent application JP 2023-109733 filed on Jul. 4, 2023, the entire content of which is hereby incorporated by reference into this application.

### BACKGROUND

### Technical Field

The present disclosure relates to a membrane electrode assembly.

### Background Art

A solid polymer fuel cell generally includes a membrane electrode assembly (also referred to as “MEA”). The membrane electrode assembly includes a solid polymer electrolyte membrane as an electrolyte membrane, an anode catalyst layer disposed on one surface of the solid polymer electrolyte membrane, and a cathode catalyst layer disposed on the other surface of the solid polymer electrolyte membrane. The anode catalyst layer functions as a fuel electrode, and the cathode catalyst layer functions as an air electrode. Gas diffusion layers are further disposed to both surfaces of the MEA in some cases, and this configuration is referred to as a membrane electrode gas diffusion layer assembly (also referred to as “MEGA”).

Here, in the solid polymer fuel cell, during power generation, hydrogen peroxide (H₂O₂) is generated from water and oxygen, and hydroxyl radicals (·OH) are generated from the hydrogen peroxide in the catalyst layer in some cases. The hydrogen peroxide and the hydroxyl radicals cause deterioration of electrolyte resins, such as ionomer, included in the solid polymer electrolyte membrane and the catalyst layers.

Therefore, there has been proposed a technique to detoxify hydrogen peroxide radicals generated during power generation of a fuel cell by containing a radical quenching agent, such as cerium ions, in an MEA. Detoxification of hydrogen peroxide radicals is, for example, a reaction from hydrogen peroxide radicals to water.

For example, JP 2008-130460 A discloses a solid polymer electrolyte membrane which includes a polymer electrolyte having sulfonate groups, and contains any of the following (a) to (c): (a) cerium ions and an organic compound (X) capable of forming an inclusion compound with cerium ions; (b) an inclusion compound (Y) including the organic compound (X) including cerium ions; and (c) at least one of cerium ions or the organic compound (X), and the inclusion compound (Y). JP 2008-130460 A discloses that the solid polymer electrolyte membrane of JP 2008-130460 A has excellent resistance to hydrogen peroxide or peroxide radicals. It discloses that the reason is not necessarily clear, but it is estimated as follows. By the electrolyte membrane containing cerium ions and the organic compound (X), at least part of them form the inclusion compound, which interacts with sulfonate groups (—SO₃—), whereby part of the sulfonate groups are ion-exchanged with the inclusion compound (Y) to form a predetermined structure, thus effectively improving resistance of the polymer electrolyte membrane to hydrogen peroxide or peroxide radicals.

### SUMMARY

As described above, in JP 2008-130460 A, a polymer electrolyte membrane or an anode catalyst layer containing cerium ions as a radical quenching agent and 18-crown-6 ether is disclosed.

However, upon investigating the membrane electrode assembly containing cerium ions and 18-crown-6 ether, a decrease in performance during use was recognized, proving that there is room for improvement in terms of durability.

Therefore, the present disclosure provides a membrane electrode assembly having excellent durability.

The present inventors have intensively studied to solve the above-described problem, and found that one of the reasons for the decrease in the performance described above is that cerium ions move and segregate in the electrode during use, and a low-concentration portion of cerium ions is generated. The present inventors have further advanced the study and discovered that the durability can be improved by using a crown ether compound comprising an amino group or a salt thereof, thus achieving the present disclosure.

Exemplary aspects of the embodiment is as follows.
(1) A membrane electrode assembly comprising:
   a solid polymer electrolyte membrane;
   an anode catalyst layer disposed on one surface of the solid polymer electrolyte membrane; and
   a cathode catalyst layer disposed on the other surface of the solid polymer electrolyte membrane,
   wherein the membrane electrode assembly comprises metal ions selected from cerium ions and manganese ions, and a host compound capable of forming an inclusion compound with the metal ions, and
   wherein the host compound is a crown ether compound comprising an amino group or a salt thereof.
(2) The membrane electrode assembly according to (1), wherein the host compound is a crown ether compound having an aromatic ring or an aliphatic ring substituted by an amino group or a salt thereof.
(3) The membrane electrode assembly according to (1) or (2), wherein the host compound is a crown ether compound having a repeating structure of (—CH₂—CH₂—Y—) units or (—CH₂—CH₂—CH₂—Y—) units or a salt thereof, wherein each Y is independently selected from —O—, —NH—, or —NR—, at least one Y is selected from —NH— or —NR—, each R is independently an alkyl group having 1 to 6 carbon atoms, and when two R exist, the two R may be linked to each other via C₁ to C₆ alkylene in which one or two carbon atoms may be replaced by an oxygen atom.
(4) The membrane electrode assembly according to any one of (1) to (3), wherein the host compound is a crown ether compound having a repeating structure of (—CH₂—CH₂—Y—) units or (—CH₂—CH₂—CH₂—Y—) units or a salt thereof, wherein each Y is independently selected from —O— or —NR—, at least one Y is selected from —NR—, each R is independently an alkyl group having 1 to 4 carbon atoms, and when two R exist, the two R may be linked to each other via C₁ to C₆ alkylene in which one or two carbon atoms may be replaced by an oxygen atom.
(5) The membrane electrode assembly according to any one of (1) to (4), wherein the salt of the crown ether compound comprising an amino group is nitrate, sulfate, carbonate, acetate, or propionate.

The present disclosure allows providing the membrane electrode assembly having excellent durability.

### BRIEF DESCRIPTION OF THE DRAWINGS

FIG. 1 is a schematic cross-sectional view for describing an exemplary configuration of a membrane electrode assembly and a solid polymer fuel cell according to the embodiment and cross-sectional view of a main part of an exemplary fuel cell 10.

### DETAILED DESCRIPTION

The embodiment is a membrane electrode assembly that comprises: a solid polymer electrolyte membrane; an anode catalyst layer disposed on one surface of the solid polymer electrolyte membrane; and a cathode catalyst layer disposed on the other surface of the solid polymer electrolyte membrane, wherein the membrane electrode assembly comprises metal ions selected from cerium ions and manganese ions and a host compound capable of forming an inclusion compound with the metal ions, and wherein the host compound is a crown ether compound comprising an amino group or a salt thereof.

The embodiment allows providing the membrane electrode assembly having durability. In the embodiment, cerium ions and/or manganese ions that function as a radical quenching agent are added in the membrane electrode assembly (such as the anode catalyst layer or the solid polymer electrolyte membrane). Since hydrogen peroxide radicals can be trapped and detoxified by cerium ions and/or manganese ions, deterioration of the membrane electrode assembly can be suppressed. Additionally, by adding the host compound for the above-described metal ions in the membrane electrode assembly, movement of the above-described metal ions can be suppressed, reducing concentration bias in a planar direction. At that time, by using the crown ether compound comprising an amino group or a salt thereof as the host compound, the effect of suppressing movement of the metal ions can be further improved. Therefore, the membrane electrode assembly according to the embodiment also allows having excellent durability.

The following describes a configuration of the embodiment.

A solid polymer electrolyte membrane has a function to block distribution of electrons and gases, and to move protons (H+) generated in an anode from an anode side catalyst layer to a cathode side catalyst layer. As the solid polymer electrolyte membrane in the embodiment, an electrolyte membrane having proton conductivity known in the technical field can be used. As the solid polymer electrolyte membrane, for example, a membrane formed of a fluororesin having sulfonate group as an electrolyte (such as Nafion (produced by DuPont), FLEMION (produced by AGC Inc.), and Aciplex (produced by Asahi Kasei Corporation)) can be used.

While the thickness of the solid polymer electrolyte membrane is not particularly limited, it is, for example, 5 μm to 50 μm from the aspect of improvement in proton conductivity.

The cathode catalyst layer functions as an air electrode (oxygen electrode).

The cathode catalyst layer includes at least an electrode catalyst (also simply referred to as “catalyst”) and an electrolyte. In some embodiments, the electrode catalyst is a metal-supported catalyst. In the metal-supported catalyst, a metal catalyst is supported on a carrier.

As the carrier, a carrier known in the technical field can be used and is not particularly limited. Examples of the carrier include, for example, a carbon material, such as carbon black, a carbon nanotube, and a carbon nanofiber; and a carbon compound, such as silicon carbide. For the carrier, one kind may be used alone, or two or more kinds may be used in combination.

The metal catalyst is not particularly limited as long as it exhibits a catalytic action in a reaction at the electrodes.

Air electrode(cathode):O₂+4H⁺+4e⁻→2H₂O

Hydrogen electrode(anode):2H₂→4H⁺+4e⁻

The metal catalyst is not specifically limited, and, for example, platinum, palladium, rhodium, gold, argentum, osmium, iridium, or an alloy containing two or more of them can be used. Additionally, the platinum alloy is not specifically limited, and, for example, an alloy of platinum and at least one of aluminum, chrome, manganese, iron, cobalt, nickel, gallium, zirconium, molybdenum, ruthenium, rhodium, palladium, vanadium, tungsten, rhenium, osmium, iridium, titanium, or lead can be used. One metal catalyst may be used alone, or two or more metal catalysts may be used in combination.

While the content of the electrode catalyst in the cathode catalyst layer is not particularly limited, for example, the content is 3 mass % to 40 mass % of the total mass of the catalyst layer.

The electrolyte used for the cathode catalyst layer is an ionomer having sulfonate groups in some embodiments. The ionomer is also referred to as cation-exchange resin, and is present as a cluster formed of ionomer molecules. The ionomer is not specifically limited, and, for example, the ionomer known in the technical field can be used. Examples of the ionomer include: fluororesin-based electrolyte, such as perfluorosulfonic acid resin; sulfonated plastic-based electrolyte, such as sulfonated polyether ketone, sulfonated polyethersulfone, sulfonated polyether ether sulfone, sulfonated polysulfone, sulfonated polysulfide, and sulfonated polyphenylene; and sulfoalkylated plastic-based electrolyte, such as sulfoalkylated polyether ether ketone, sulfoalkylated polyethersulfone, sulfoalkylated polyetherethersulfone, sulfoalkylated polysulfone, sulfoalkylated polysulfide, and sulfoalkylated polyphenylene. One electrolyte may be used alone, or two or more electrolytes may be used in combination.

The anode catalyst layer functions as a fuel electrode, that is, a hydrogen electrode.

The anode catalyst layer includes an electrode catalyst and an ionomer. The ionomer is an ionomer having a sulfonate group in some embodiments. Examples of the ionomer having a sulfonate group include those described above. In one embodiment, the anode catalyst layer can contain, in addition to the electrode catalyst and the ionomer, metal ions selected from cerium ions and manganese ions, and a host compound capable of forming an inclusion compound with the metal ions.

While the electrode catalyst is not particularly limited, for example, the above-described materials can be used.

While the ionomer having a sulfonate group is not specifically limited, examples thereof include a polymer electrolyte resin having ionic conductivity, such as a perfluorosulfonic acid ionomer. Specific examples of the ionomer having a sulfonate group include Nafion and Aquivion (Solvay S.A.).

The membrane electrode assembly according to the embodiment includes metal ions selected from cerium ions and manganese ions, and a host compound capable of forming an inclusion compound with the metal ions. Since cerium ions and/or manganese ions function as a radical quenching agent and can trap and detoxify hydrogen peroxide radicals, deterioration of the membrane electrode assembly can be suppressed. Additionally, by adding the host compound for the above-described metal ions in the membrane electrode assembly, movement of the above-described metal ions can be suppressed, reducing concentration bias in a planar direction.

The metal ions are selected from cerium ions and manganese ions. The cerium ions and the manganese ions function as a radical quenching agent. The radical quenching agent can facilitate conversion of hydroxyl radicals generated from hydrogen peroxide into hydroxide ions, suppressing deterioration of the anode catalyst layer. For example, the reaction of the hydroxyl radicals to the hydroxide ions by the cerium ions is as follows.

Ce³⁺+·OH(hydroxyl radicals)→Ce⁴⁺+OH⁻(hydroxide ions)

The cerium ions may be positive trivalent ions or may be positive quadrivalent ions. The manganese ions may be positive trivalent ions or may be positive quadrivalent ions.

While a cerium salt for obtaining the cerium ions is not particularly limited, examples of the cerium salt include cerium nitrate, cerium carbonate, cerium acetate, cerium chloride, ceric sulfate, diammonium cerium nitrate, or tetraammonium cerium sulfate. For the cerium salt, one kind may be used alone, or two or more kinds may be used in combination. The cerium salt may be an organometallic complex salt. Examples of the organometallic complex salt include, for example, cerium acetylacetonate.

While a manganese salt for obtaining the manganese ions is not particularly limited, examples of the manganese salt include manganese nitrate, manganese carbonate, manganese acetate, manganese chloride, or manganese sulfate. For the manganese salt, one kind may be used alone, or two or more kinds may be used in combination.

The host compound in the embodiment forms an inclusion compound with the cerium ions or the manganese ions as a guest compound. The inclusion compound means an addition compound having a configuration in which the above-described metal ions as a guest compound are included in the host compound. For the host compound, one kind may be used alone, or two or more kinds may be used in combination.

The host compound in the embodiment is a crown ether compound comprising an amino group or a salt thereof. The number of ring members of the host compound is 15 or more in some embodiments, and 18 or more in some embodiments. The crown ether compound comprising an amino group or a salt thereof tends to donate electrons to metal ions, such as cerium ions, and form a coordination bond, which results in allowing an inclusion compound to be formed more effectively.

In the present specification, the crown ether compound is a compound having a cyclic structure having a repeating structure of (—CH₂—CH₂—Y—) units or (—CH₂—CH₂—CH₂—Y—) units, and each Y is independently selected from —O—, —NH—, or —NR—. The crown ether compound can trap metal ions in this ring structure to form an inclusion compound. The crown ether compound comprising an amino group (including a primary amino group, a secondary amino group, and a tertiary amino group) may have the amino group in the cyclic structure (a form in which the above-described Y is —NH— or —NR—), or may have the amino group as a substituent. The amino group as a substituent are represented as —NR₁R₂, and the R₁ and the R₂ are each independently a hydrogen atom or an alkyl group having 1 to 4 carbon atoms.

In one embodiment, the crown ether compound comprising an amino group or a salt thereof is a crown ether compound having an aromatic ring or an aliphatic ring having an amino group as a substituent (a crown ether compound having an aromatic ring or an aliphatic ring substituted by an amino group or a salt thereof). In the crown ether compound having an aromatic ring or an aliphatic ring having an amino group, in addition to the effect of the amino group donating electrons to metal ions, such as cerium ions, and forming a coordination bond, the aromatic ring or aliphatic ring structure provides high hydrophobicity. Therefore, the crown ether compound having an aromatic ring or an aliphatic ring having an amino group is suppressed from transitioning to other layers (such as the cathode catalyst layer). Examples of the crown ether compound having the aromatic ring or the aliphatic ring include benzo-15-crown-5-ether, dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, or dicyclohexano-24-crown-8-ether, and examples of the crown ether compound comprising an amino group include compounds in which the aromatic ring or the aliphatic ring of these compounds is substituted by at least one amino group. The number of substituents is, for example, from 1 to 4, from 1 to 3, 1 or 2, or 1. Examples of the crown ether compound comprising an amino group specifically include aminobenzo-15-crown-5-ether, aminobenzo-18-crown-6-ether, aminobenzo-21-crown-7-ether, and aminobenzo-24-crown-8-ether. For the compounds, one kind may be used alone, or two or more kinds may be used in combination.

Examples of the salt of the crown ether compound comprising an amino group include nitrate, sulfate, carbonate, acetate, or propionate. For the salt, one kind may be used alone, or two or more kinds may be used in combination.

In one embodiment, the host compound is ammonium salt of the crown ether compound having an aromatic ring or an aliphatic ring substituted by an amino group. By adding the host compound in the state of ammonium salt into a catalyst ink, an interaction of the ionomer with a sulfonate group decreases, and it is possible to avoid aggregation of the host compound and the ionomer in the catalyst ink. As a result, productivity can be improved. Examples of the acid that forms the ammonium salt include nitric acid, sulfuric acid, or carbonic acid.

In one embodiment, the crown ether compound comprising an amino group or a salt thereof is a crown ether compound having a repeating structure of (—CH₂—CH₂—Y—) units or (—CH₂—CH₂—CH₂—Y—) units or a salt thereof, wherein each Y is independently selected from —O—, —NH—, or —NR—, at least one Y is selected from —NH— or —NR—, each R is independently an alkyl group having 1 to 4 carbon atoms, and when two R exist, the two R may be linked to each other via C₁ to C₆ alkylene in which one or two carbon atoms may be replaced by an oxygen atom. The “C₁ to C₆ alkylene in which one or two carbon atoms may be replaced by an oxygen atom” that link the two R is, for example, —O—(C₁ to C₄ alkylene)—O—. The crown ether compound comprising the secondary amino group (secondary amino) or the tertiary amino group (tertiary amino) in the cyclic structure can trap metal ions inside this ring structure, efficiently form an inclusion compound, and effectively suppress the movement and segregation of the metal ions. Examples of the crown ether compound in this embodiment specifically includes 1-aza-15-crown-5-ether, 1-aza-1-methyl-15-crown-5-ether, 1-aza-18-crown-6-ether, 1-aza-1-methyl-18-crown-6-ether, 1-aza-21-crown-7-ether, 1-aza-1-methyl-21-crown-7-ether, 1-aza-24-crown-8-ether, 1-aza-1-methyl-24-crown-8-ether, and Cryptand 222. The salt is ammonium salt in some embodiments. By adding the salt in the state of ammonium salt into the catalyst ink, the interaction of the ionomer with a sulfonate group decreases, and the generation of aggregation of the host compound and the ionomer in the catalyst ink can be suppressed. As a result, productivity can be improved.

In one embodiment, the host compound is the crown ether compound having a repeating structure of (—CH₂—CH₂—Y—) units or (—CH₂—CH₂—CH₂—Y—) units or a salt thereof, wherein each Y is independently selected from —O— or —NR—, at least one Y is selected from —NR—, each R is independently an alkyl group having 1 to 4 carbon atoms, and when two R exist, the two R may be linked to each other via C₁ to C₆ alkylene in which one or two carbon atoms may be replaced by an oxygen atom. In the crown ether compound comprising the tertiary amino group (tertiary amino compound) in the cyclic structure, in addition to having the effect of suppressing movement of metal ions, since there is little interaction of the ionomer with a sulfonate group in the catalyst ink, the generation of aggregation of the host compound and the ionomer in the catalyst ink can be suppressed. As a result, productivity can be improved.

In the membrane electrode assembly of the embodiment, at least part of the host compound and the metal ions form an inclusion compound.

The host compound and the metal ions can be contained in the anode catalyst layer, the solid polymer electrolyte membrane, or both of them.

When the anode catalyst layer contains the host compound and the metal ions, the anode catalyst layer contains at least an electrode catalyst, an electrolyte, metal ions selected from cerium ions and manganese ions, and metal ions and a host compound. The above-described metal ions can facilitate conversion of hydroxyl radicals generated from hydrogen peroxide into hydroxide ions, suppressing deterioration of the anode catalyst layer.

In some embodiments, the content of the above-described metal ions and the host compound in the anode catalyst layer is 0.1 mass % to 20 mass % of the total amount of the solid content of the anode catalyst layer. Regarding the content, the inclusion compound is regarded as a mixture of the metal ions and the host compound. That is, when the above-described metal ions and the host compound are added in the anode catalyst layer separately or simply in a mixed manner, only the total amount of the compound metal ions and host compound is subject to calculation, without considering the amount of an inclusion compound generated in the polymer electrolyte even when it is generated. Additionally, when an inclusion compound is formed in advance, and then the inclusion compound is added in the anode catalyst layer, the amount of the inclusion compound is the total amount of the metal ions and the host compound forming the inclusion compound. Furthermore, when metal ions and a host compound, which do not form an inclusion compound, further exist other than the metal ions and the host compound that form an inclusion compound, they are also subject to calculation.

For the relative ratio of the host compound to the above-described metal ions in the embodiment, the mole ratio of the host compound to the above-described metal ions ([number of moles of host compound]/[number of moles of metal ions]) is, for example, 0.1 to 10, is 0.2 to 7.5 in some embodiments, and may be 0.4 to 5.0. That is, the content of the host compound with respect to 1 mole of the above-described metal ions is, for example, 0.1 moles to 10 moles, is 0.2 moles to 7.5 moles in some embodiments, and may be 0.4 moles to 5.0 moles in some embodiments. Similarly to the above, the inclusion compound is regarded as a mixture of both of them also in the relative ratio.

When the solid polymer electrolyte membrane contains the host compound and the metal ions, the solid polymer electrolyte membrane that contains the host compound and the metal ions can be obtained by, for example, the following methods.
(1) After a solid polymer electrolyte membrane is immersed in a solution containing metal ions to exchange ions of groups, such as a sulfonate group, with the metal ions, the solid polymer electrolyte membrane is immersed in a solution containing a host compound such that the host compound is included in the membrane.
(2) A method of producing a membrane by coating using a liquid obtained as follows. After a compound containing metal ions (such as cerium salt) is added in a dispersion liquid of polymer electrolytes to exchange ions of groups, such as a sulfonate group, with the metal ions, a solution or solid containing a host compound is added to the dispersion liquid to obtain the liquid.
(3) A method in which a compound containing metal ions (such as cerium salt) and a host compound are caused to react in a solvent to form an inclusion compound, and next, a solid polymer electrolyte membrane is immersed in a solution in which the inclusion compound is dissolved in the solvent to exchange ions of groups, such as a sulfonate group, with the inclusion compound such that the inclusion compound is included in the membrane.
(4) A compound comprising metal ions (such as cerium salt) and a host compound are caused to react in a solvent to form an inclusion compound. Next, the inclusion compound or its solution is added in a dispersion liquid of polymer electrolytes to obtain a liquid. A membrane is produced by coating using the obtained liquid.

### [Method for Manufacturing Membrane Electrode Assembly]

A catalyst layer can be formed by, for example, a process of preparing a catalyst ink (for example, a solid content concentration of about 10%) including an electrode catalyst, an ionomer, and a solvent, a process of applying the catalyst ink over a substrate surface and volatilizing the solvent in the coating film to form a catalyst layer on the substrate surface, and a process of transferring the catalyst layer on the substrate surface to an electrolyte membrane. In addition, a catalyst layer can be formed by a method of directly applying the catalyst ink over a solid polymer electrolyte membrane instead of the substrate. By forming a cathode catalyst layer and an anode catalyst layer on the solid polymer electrolyte membrane, a membrane electrode assembly can be produced.

Examples of a method for applying the catalyst ink include, for example, a spray method, a blade coating method using a doctor blade or an applicator, a die coating method, a reverse roll coater method, and an intermittent die coating method.

For the anode catalyst layer, the above-described metal ions and the above-described host compound may be contained in a catalyst ink for forming the anode catalyst layer. Specifically, the catalyst ink for forming the anode catalyst layer can include an electrode catalyst, an ionomer (for example, an ionomer having a sulfonate group), the above-described metal ions, the host compound, and a solvent. The above-described metal ions and host compound may be each added separately or may be added in a form of a complex of both.

### [Specific Configurations of Membrane Electrode Assembly and Solid Polymer Fuel Cell]

The basic unit of a solid polymer fuel cell is a membrane electrode assembly (MEA) in which catalyst layers (electrodes) are assembled to both surfaces of a solid polymer electrolyte membrane. In the solid polymer fuel cell, gas diffusion layers are generally disposed on external sides of the catalyst layers. The gas diffusion layers are for supplying a reaction gas and electrons to the catalyst layers, and carbon paper, carbon cloth, and the like are used. The catalyst layers are portions that become reaction fields of an electrode reaction.

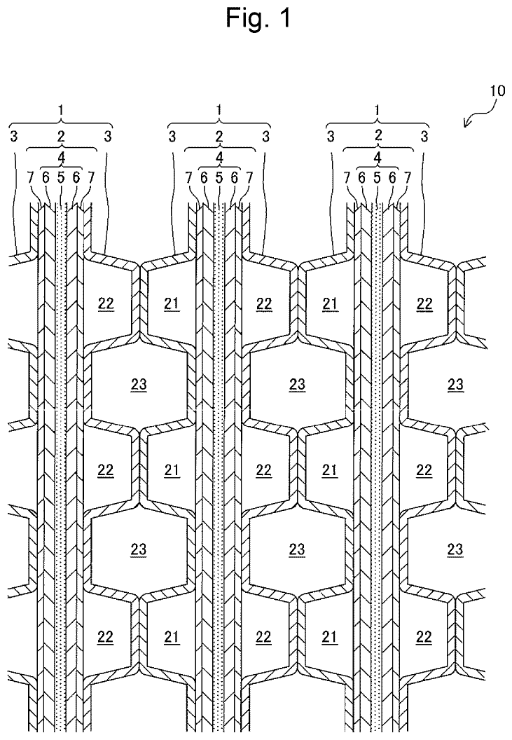

The following describes the configurations of the membrane electrode assembly and the solid polymer fuel cell with reference to FIG. 1. FIG. 1 is a schematic cross-sectional view for describing an exemplary configuration of the solid polymer fuel cell according to the embodiment and cross-sectional view of a main part of an exemplary fuel cell 10. The solid polymer fuel cell includes a stacked body of unit cells constituted of an electricity generating body and fuel cell separators disposed on both surfaces of the electricity generating body. The plurality of unit cells are stacked in a stacking direction, and the respective unit cells are electrically connected in series. As illustrated in FIG. 1, in the fuel cell 10, a plurality of unit cells 1 as a basic unit are stacked. Each unit cell 1 is a solid polymer fuel cell that generates an electromotive force by an electrochemical reaction between an oxidant gas (such as air) and a fuel gas (such as hydrogen). The unit cell 1 includes a membrane electrode gas diffusion layer assembly (MEGA) 2 and separators 3 in contact with the MEGA 2 so as to partition the MEGA 2. On both sides of the MEGA 2, gas diffusion layers (GDL) 7 are disposed. In the embodiment, the MEGA 2 are sandwiched by a pair of separators 3, 3.

The MEGA 2 includes a membrane electrode assembly (MEA) 4 and gas diffusion layers 7, 7 disposed on both surfaces of the membrane electrode assembly 4. The membrane electrode assembly 4 is constituted of an electrolyte membrane 5 and a pair of electrodes 6, 6 assembled to sandwich the electrolyte membrane 5. The electrolyte membrane 5 is, for example, a proton-conductive ion exchange membrane formed of a solid polymer material. The electrode 6 includes, for example, a porous carbon material supporting a catalyst, such as platinum. The electrode 6 disposed on one side of the electrolyte membrane 5 functions as an anode, and the electrode 6 on the other side functions as a cathode. The gas diffusion layer 7 is formed of a conductive member having gas permeability. Examples of the conductive member having gas permeability include, for example, a carbon porous body, such as carbon paper or carbon cloth, or a metal porous body, such as metal mesh or foam metal. In the embodiment, the anode electrode is constituted of an anode catalyst layer, and the cathode electrode is constituted of a cathode catalyst layer.

### EXAMPLES

The following describes the embodiment using examples.

### Example 1

### (Formation of Cathode Catalyst Layer)

A metal-supported catalyst as an electrode catalyst was dispersed in an ionomer solution (DE2020) including water and ethanol using a bead mill to prepare a catalyst ink. The mass ratio of water to ethanol (water/ethanol) in the catalyst ink was about 1. The obtained catalyst ink was coated over a polytetrafluoroethylene sheet and dried to form a cathode catalyst layer.

The Pt weight per unit area in the cathode catalyst layer was 0.2 mg/cm², and the mass ratio of ionomer to carbon (I/C) was 1.0. As catalyst particles, 30% Pt/Vulcan (registered trademark) (produced by Tanaka Kikinzoku Kogyo, TEC10V30E) was used.

### (Formation of Inclusion Compound (Complex))

4′-aminobenzo-15-crown-5-ether (also known as (benzo-15-crown-5)-4′-ylamine, Tokyo Chemical Industry) (0.01 mol) were weighed and taken into a 100 mL eggplant flask and stirred at room temperature for 24 hours with ethanol (20 mL) and water (20 mL) added. Then, after the solution was removed with an evaporator, vacuum drying was performed under 60° C. for one hour to obtain a solid. By confirming that the peak derived from ether groups shifted to a low wavenumber side by FT-IR, it was confirmed that a compound and Ce formed an inclusion compound.

### (Formation of Anode Catalyst Layer)

As an electrode catalyst, 60 wt % Pt/Ketjen (registered trademark) was used. The electrode catalyst and the above-described complex were dispersed in an ionomer solution (DE2020) including water, ethanol, and Nafion (registered trademark) to prepare a catalyst ink. The catalyst ink was coated over a polytetrafluoroethylene sheet and dried to form an anode catalyst layer.

The Pt weight per unit area in the anode catalyst layer was 0.1 mg/cm², and the cerium ion concentration was 4 μg/cm². As described above, a host compound was contained in a ratio of Ce:host compound=1:1 mol. The mass ratio of ionomer to carbon (I/C) was 1.0.

### (Production of Membrane Electrode Assembly)

The obtained cathode catalyst layer and anode catalyst layer were heat-transferred to both respective surfaces of a Nafion (registered trademark) membrane (NR211) to produce a membrane electrode assembly E1. The heat transfer conditions were set to 140° C., 50 kgf/cm² (4.90 MPa), and 5 min. The electrode area of the membrane electrode assembly for initial performance test was 1 cm×1 cm (1 cm²). The electrode area of the membrane electrode assembly for durability test was 3.6 cm×3.6 cm (12.96 cm²). The membrane electrode assembly was sandwiched by paper diffusion layers (GDL) with water-repellent layers to produce a test cell.

### Example 2

A membrane electrode assembly E2 was produced similarly to Example 1 except that 1-aza-18-crown-6-ether (also known as 1,4,7,10,13-pentaoxa-16-azacyclooctadecane, Tokyo Chemical Industry) (0.01 mol) was used as a host compound.

### Example 3

A membrane electrode assembly E3 was produced similarly to Example 1 except that 1-aza-1-methyl-18-crown-6-ether (0.01 mol) was used as a host compound. The 1-aza-1-methyl-18-crown-6-ether was synthesized in the following method.

In a three-necked flask provided with a thermometer and a stirrer, 263 g (1 mol) of 1-aza-18-crown-6-ether and 75 g (2.5 mol) of formaldehyde were dissolved in 500 mL of methanol. Into the obtained solution, 164 g (2 moles) of sodium acetate, 240 g (2 moles) of acetic acid, and 46.1 g (0.7 moles) of sodium cyanoborohydride were added, and stirred for two hours at 25° C. while performing nitrogen substitution. After the reaction was completed, the solution was subjected to separation to obtain 1-aza-1-methyl-18-crown-6-ether as a N-methylated product. By using 1H-NMR and MS, it was confirmed that the compound was obtained.

### Example 4

A membrane electrode assembly E4 was produced similarly to Example 1 except that Cryptand 222 (also known as 4,7,13,16,21,24-hexaoxa-1,10-diazabicyclo [8.8.8] hexacosane, Tokyo Chemical Industry) (0.01 mol) was used as a host compound.

### Example 5

A membrane electrode assembly E5 was produced similarly to Example 1 except that nitrate (0.01 mol) of 1-aza-18-crown-6-ether was used as a host compound. The nitrate of 1-aza-18-crown-6-ether was obtained as follows. 1-aza-18-crown-6-ether and nitrate were weighed in a ratio of 1:1 mol in a 100 mL eggplant flask, added to a mixed solvent of ethanol and water, and stirred at room temperature for 24 hours. Then, the solvent was removed using an evaporator, and by performing vacuum drying at 60° C. for 1 hour, the nitrate of 1-aza-18-crown-6-ether was obtained.

### Example 6

A membrane electrode assembly E6 was produced similarly to Example 1 except that nitrate (0.01 mol) of 4′-aminobenzo-15-crown-5-ether was used as a host compound. The nitrate of 4′-aminobenzo-15-crown-5-ether was obtained as follows. 4-aminobenzo-15-crown-5-ether and nitrate were weighed in a ratio of 1:1 mol in a 100 mL eggplant flask, added to a mixed solvent of ethanol and water, and stirred at room temperature for 24 hours. Then, the solvent was removed using an evaporator, and by performing vacuum drying at 60° C. for 1 hour, the nitrate of 4′-aminobenzo-15-crown-5-ether was obtained.

### Comparative Example 1

A membrane electrode assembly C1 was produced similarly to Example 1 except that a host compound was not used.

### Comparative Example 2

A membrane electrode assembly C2 was produced similarly to Example 1 except that 18-crown-6-ether (also known as 1,4,7,10,13,16-hexaoxacyclooctadecane, Tokyo Chemical Industry) (0.01 mol) was used as a host compound.

### [Evaluation]

### (Durability Test: Voltage Decrease Rate)

The above-described test cells (electrode area: 12.96 cm²) were incorporated in a cell for power generation to conduct the durability test under a low-humidify environment (90° C., 40% RH). In the durability test, the initial characteristics of the solid polymer fuel cell and the characteristics after the durability test load were evaluated at a cell temperature of 90° C., with hydrogen/air supplied, and at a current density of 0.05 A/cm². Hydrogen and air were each humidified so as to have a dew point of 67° C. on the anode side and a dew point of 67° C. on the cathode side and supplied into a cell, and the cell voltage at the beginning of operation and the relationship between an elapsed time after starting the operation and the cell voltage were measured. The results are shown in Table 1 below. Under the above-described cell evaluation conditions, the cell voltage at the beginning of the operation and the cell voltage after a lapse of 200 hours after starting the operation were measured.

### (Productivity: Particle Size)

### <Method for Measuring Particle Size Distribution>

A particle size distribution of a catalyst ink was measured using a particle size distribution analyzer (MT3000II) manufactured by MicrotracBEL, and the value of D50 was used. The particle size distribution D50 (unit: μm) of the catalyst ink is indicated as A when it was 5 μm or less, and D50 is indicated as B when it was 6 μm to 10 μm.

TABLE 1

| | Durability Test | | | | |
|---|---|---|---|---|---|
| | | Voltage at | Voltage | Ce | |
| | Voltage at | 0.05 A/cm² (V) | Decrease | Remaining | Particle Size of |
| | 0.05 A/cm² (V) | (After Elapse | Rate | Amount | An Catalyst Ink |
| | (Initial) | of 200 Hours) | (%) | (%) | A-B |
| Example 1 | 0.81 | 0.74 | 9 | 78 | B |
| Example 2 | 0.82 | 0.75 | 9 | 75 | B |
| Example 3 | 0.81 | 0.77 | 5 | 73 | A |
| Example 4 | 0.82 | 0.79 | 4 | 84 | A |
| Example 5 | 0.81 | 0.74 | 9 | 76 | A |
| Example 6 | 0.80 | 0.74 | 8 | 73 | A |
| Comparative Example 1 | 0.81 | 0.63 | 22 | 38 | A |
| Comparative Example 2 | 0.79 | 0.66 | 16 | 55 | A |

Upper limit values and/or lower limit values of respective numerical ranges described in the present specification can be appropriately combined to specify an appropriate range. For example, upper limit values and lower limit values of the numerical ranges can be appropriately combined to specify an appropriate range, upper limit values of the numerical ranges can be appropriately combined to specify an appropriate range, and lower limit values of the numerical ranges can be appropriately combined to specify an appropriate range.

While the embodiment has been described in detail, the specific configuration is not limited to the embodiment. Design changes within a scope not departing from the gist of the present disclosure are included in the present disclosure.

### DESCRIPTION OF SYMBOLS

1 Cell
2 MEGA (membrane electrode gas diffusion layer assembly)
3 Separator (fuel cell separator)
4 Membrane electrode assembly (MEA)
6 Electrode
7 Gas diffusion layer
10 Fuel cell
21, 22 Gas flow channel

What is claimed is:

1. A membrane electrode assembly comprising:
a solid polymer electrolyte membrane;
an anode catalyst layer disposed on one surface of the solid polymer electrolyte membrane; and
a cathode catalyst layer disposed on the other surface of the solid polymer electrolyte membrane,
wherein the membrane electrode assembly comprises metal ions selected from cerium ions and manganese ions, and a host compound capable of forming an inclusion compound with the metal ions, and
wherein the host compound is a crown ether compound comprising an amino group or a salt thereof.

2. The membrane electrode assembly according to claim 1,
wherein the host compound is a crown ether compound having an aromatic ring or an aliphatic ring substituted by an amino group or a salt thereof.

3. The membrane electrode assembly according to claim 1,
wherein the host compound is a crown ether compound having a repeating structure of (—CH₂—CH₂—Y—) units or (—CH₂—CH₂—CH₂—Y—) units or a salt thereof, wherein each Y is independently selected from —O—, —NH—, or —NR—, at least one Y is selected from —NH— or —NR—, each R is independently an alkyl group having 1 to 6 carbon atoms, and when two R exist, the two R may be linked to each other via C₁ to C₆ alkylene in which one or two carbon atoms may be replaced by an oxygen atom.

4. The membrane electrode assembly according to claim 1,
wherein the host compound is a crown ether compound having a repeating structure of (—CH₂—CH₂—Y—) units or (—CH₂—CH₂—CH₂—Y—) units or a salt thereof, wherein each Y is independently selected from —O— or —NR—, at least one Y is selected from —NR—, each R is independently an alkyl group having 1 to 4 carbon atoms, and when two R exist, the two R may be linked to each other via C₁ to C₆ alkylene in which one or two carbon atoms may be replaced by an oxygen atom.

5. The membrane electrode assembly according to claim 1,
wherein the salt of the crown ether compound comprising an amino group is nitrate, sulfate, carbonate, acetate, or propionate.
